(19) United States
(12) Patent Application Publication
(10) Pub. No.: US 2026/0019199 A1
(43) Pub. Date: Jan. 15, 2026

(54) TRANSMITTER-BASED SEQUENCE NUMBER REPORTING IN RADIO LINK CONTROL

(71) Applicant: Lenovo (Singapore) Pte Ltd, Singapore (SG)

(72) Inventors: Shwetha Sreejith, Steinbach (DE); Joachim Löhr, Wiesbaden (DE); Prateek Basu Mallick, Dreieich (DE)

(73) Assignee: Lenovo (Singapore) Pte Ltd, Singapore (SG)

(21) Appl. No.: 18/773,225

(22) Filed: Jul. 15, 2024

(51) Int. Cl. H04L 1/1867; H04L 1/1607; H04W 28/06

(52) U.S. Cl. CPC H04L 1/188; H04L 1/1621; H04W 28/06

(57) ABSTRACT

Various aspects of the present disclosure relate to sequence number reporting in radio link control (RLC). An apparatus, such as a UE, receives a configuration associated with RLC of the UE, where the configuration indicates a threshold number of retransmissions for reporting one or more sequence numbers (SNs) associated with one or more RLC protocol data units (PDUs) and a timer associated with retransmission of the reporting of the one or more SNs associated with the one or more RLC PDUs. The UE transmits an SN report that indicates the one or more SNs, activates the timer according to the configuration and in response to the transmitted SN report, and sets a value of a retransmission counter according to the configuration and in response to the transmitted SN report. The UE transmits retransmissions of the SN report and increments the value of the transmission counter for each retransmission.

### TECHNICAL FIELD

The present disclosure relates to wireless communications, and more specifically to transmitter-based sequence number (SN) reporting in radio link control (RLC).

### BACKGROUND

A wireless communications system may include one or multiple network communication devices, such as base stations, which may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

The wireless communications system may support wireless communications, and may include one or more devices, such as UEs, base stations (e.g., gNBs), network entities, satellites, and/or network equipment (NE), among other devices, that transmit and/or receive signaling. Some wireless communications systems support extended reality (XR) services, including augmented reality (AR) and virtual reality (VR), as well as cloud gaming (CG). To provide satisfactory user experiences, XR services require high bit rates with bounded latency and therefore are delay-critical. Additionally, XR applications require a certain minimum granularity of application data to be available on the client side before the next level of processing can start. This minimum granularity of application data may be referred to as an application data unit (ADU) or a protocol data unit (PDU) set.

Layers in a user plane protocol stack, such as a packet data convergence protocol (PDCP) layer, an RLC layer, or the like, may function independently from each other, which can lead to unnecessary transmissions and retransmissions. Such redundant transmissions may waste communication resources and increase latency in user plane functionality, which may negatively impact performance of delay-critical services such as XR.

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

Some implementations of the method and apparatuses described herein may include a UE for wireless communication to receive a configuration associated with RLC of the UE, where the configuration indicates a threshold number of retransmissions for reporting one or more SNs associated with one or more RLC protocol data units (PDUs) and a timer associated with retransmission of the reporting of the one or more SNs associated with the one or more RLC PDUs. The UE transmits an SN report that indicates the one or more SNs associated with the one or more RLC PDUs, activates the timer according to the configuration and in response to the transmitted SN report, and sets a value of a retransmission counter according to the configuration and in response to the transmitted SN report.

In some implementations of the method and apparatuses described herein, the UE performs one or more retransmissions of the SN report, and increments the value of the retransmission counter for each of the one or more performed retransmissions of the SN report. Additionally, or alternatively, the UE performs a retransmission of the SN report in response to an expiry of the timer. Additionally, or alternatively, the UE receives a status report that indicates a negative acknowledgement (NACK) associated with reception of at least one RLC PDU of the one or more RLC PDUs, and performs a retransmission of the SN report based on the received status report. The threshold number of retransmissions is satisfied based on the value of the retransmission counter being equal to the threshold number of retransmissions. To set the value of the retransmission counter, the UE sets the value of the retransmission counter to zero based on one or more RLC PDUs associated with the one or more SNs being indicated in the SN report or satisfying a condition, where the condition includes a packet delay budget (PDB), and increments the value of the retransmission counter for each instance that the one or more RLC PDUs associated with the one or more SNs are indicated in a retransmission of the SN report or a different SN report. The UE indicates that the threshold number of retransmissions is satisfied based on the value of the retransmission counter being equal to the threshold number of retransmissions.

Additionally, or alternatively, the UE receives a status report indicating successful reception of the one or more RLC PDUs, and stops the timer based on receiving the status report. Additionally, or alternatively, the UE transmits, as part of the SN report, a poll bit, where a first value of the poll bit indicates that a receiving entity is to refrain from transmitting a status report associated with the one or more RLC PDUs and a second value of the poll bit indicates that the receiving entity is to transmit the status report associated with the one or more RLC PDUs. The configuration indicates a time duration for the timer, the time duration corresponding to a round trip time for transmit and receive communications between the RLC of the UE and a receiving entity. Additionally, or alternatively, the configuration indicates a time duration for the timer, the time duration corresponding to a round trip time for transmit and receive communications between the RLC of the UE and a receiving entity plus a reassembly timer duration associated with the receiving entity. The one or more RLC PDUs include RLC PDUs for which an associated delay budget is exceeded. Additionally, or alternatively, the UE determines that an RLC PDU of the one or more RLC PDUs satisfies a condition when a PDCP discard timer of a corresponding PDCP service data unit (SDU) is expired. The UE triggers an RLF procedure based on the threshold number of retransmissions being satisfied.

Some implementations of the method and apparatuses described herein may further include a method performed by a UE, the method including receiving, from a network entity, a configuration associated with RLC of the UE, where the configuration indicates at least a threshold number of retransmissions for reporting one or more SNs associated with one or more RLC PDUs and a timer associated with retransmission of the reporting of the one or more SNs associated with the one or more RLC PDUs. The method further including transmitting an SN report that indicates the one or more SNs associated with the one or more RLC PDUs, activating the timer according to the configuration and in response to the transmitted SN report, and setting a value of a retransmission counter according to the configuration and in response to the transmitted SN report.

Some implementations of the method and apparatuses described herein may further include a processor for wireless communication to receive a configuration message associated with RLC of a UE, where the configuration indicates a threshold number of retransmissions for reporting one or more SNs associated with one or more RLC PDUs and a timer associated with retransmission of the reporting of the one or more SNs associated with the one or more RLC PDUs, transmit an SN report that indicates the one or more SNs associated with the one or more RLC PDUs, activate the timer according to the configuration and in response to the transmitted SN report, and set a value of a retransmission counter according to the configuration and in response to the transmitted SN report.

Some implementations of the method and apparatuses described herein may further include a network entity for wireless communication to configure, for RLC associated with a UE, a threshold number of retransmissions for reporting one or more SNs associated with one or more RLC PDUs and a timer associated with retransmission of the reporting of the one or more SNs associated with the one or more RLC PDUs, and transmit, to the UE, a configuration indicating the threshold number of retransmissions and the timer.

### BRIEF DESCRIPTION OF THE DRAWINGS

FIG. 1 illustrates an example of a wireless communications system in accordance with aspects of the present disclosure.

FIGS. 2A and 2B illustrate example packet reception diagrams, in accordance with aspects of the present disclosure.

FIGS. 3A and 3B illustrate example RLC control PDUs, in accordance with aspects of the present disclosure.

FIGS. 4A and 4B illustrate an example RLC configuration information element, in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

In a wireless communications system, a UE and an NE (e.g., a network entity, a base station, a gNB) support wireless communication (e.g., reception and/or transmission of wireless communication) via an over-the-air interface, e.g., as part of a RAN. For example, the UE and the NE may communicate XR traffic for XR services, which may include high resolution video and audio streams. XR traffic can be quasi-periodic with non-negligible jitter and is characterized by relatively high bit rates and relatively strict latency requirements. For instance, video and audio streams at high resolutions require substantial bandwidth. Additionally, to maintain a seamless and immersive user experience, XR applications require relatively high reliability and relatively low latency that is relatively consistent and/or predictable (e.g., low jitter). XR traffic may be referred to or understood as delay-critical traffic, time sensitive communications (TSC), time critical communications, or the like. Reference is made herein to communicating data or information, such as signaling communication resources and/or communications that are transmitted or received between devices. It is to be appreciated that other terms may be used interchangeably with communicating, such as signaling, transmitting, receiving, outputting, forwarding, retrieving, obtaining, and so forth.

User plane protocol stack functions may be enhanced to accommodate the strict requirements of XR traffic. For example, in conventional systems, a PDCP layer and an RLC layer in the user plane protocol stack function independently from each other. On a receiving side, the PDCP layer maintains a reordering window, with a defined size and range of SNs, to receive PDCP PDUs and transmit them to higher layers. Similarly, the RLC layer maintains a transmission window and a reception window, each having a defined size and range of SNs to communicate RLC PDUs with other layers. The reordering window of the PDCP layer is controlled by a timer (e.g., t-Reordering) that is configured via radio resource control (RRC), such as an RRC configuration message. When the timer expires, the PDCP layer moves the reordering window forward by updating a lower bound (e.g., a lowest SN of the range of SNs) of the reordering window. If a packet is received at the PDCP layer (e.g., at a receiving PDCP entity) outside of the reordering window (e.g., if an SN associated with the packet is outside the range of SNs), the packet is discarded by the receiving PDCP entity. In RLC acknowledge mode (AM), a receiving RLC entity moves the reception window forward when a lowest packet in the reception window (e.g., a packet with an SN that matches a lower bound of the reception window) has been successfully received and an acknowledgement (e.g., a positive acknowledgement (ACK), a NACK) has been sent for the lowest packet.

However, because these two layers function independently, the reception window and the reordering window may not be updated at the same time. The receiving PDCP entity may update the reordering window before the receiving RLC entity updates the reception window, which may result in unnecessary RLC transmissions. For example, the receiving RLC entity may attempt to recover missing packets and deliver them to the receiving PDCP entity even if the missing packets are outside of the reordering window, such that the receiving PDCP entity would discard them upon reception. Such packets may be associated with a delay budget (e.g., PDB, PDU set delay budget (PSDB)) that is exceeded and/or a PDCP discard timer that has expired, and may be referred to as outdated packets, obsolete packets, abandoned packets, or the like.

At the RLC layer, RLC AM implements automatic repeat request (ARQ) to correct errors by retransmitting lost RLC PDUs. An RLC transmitter (e.g., a transmitting side of an RLC entity, a transmitting RLC entity) maintains transmitted RLC PDUs in a retransmission buffer until the RLC transmitter receives an ACK or a NACK indicating whether a peer RLC receiver (e.g., a receiving side of the RLC entity, a receiving RLC entity) has successfully received the RLC PDUs. If the RLC transmitter receives a NACK, or fails to receive an ACK or a NACK after expiry of a timer, the RLC transmitter retransmits the RLC PDUs in the retransmission buffer. The RLC transmitter retransmits the RLC PDUs until a maximum retransmission threshold (e.g., maxRetxThreshold) is reached, which may trigger an RLF procedure. However, if, as in the example discussed above, a receiving PDCP entity has moved a reordering window forward, retransmissions of the RLC PDUs to the RLC receiver may be wasted, as the RLC receiver receives the RLC PDUs outside of the reordering window and consequently discards them.

Two approaches may be implemented to avoid unnecessary RLC transmissions (e.g., unnecessary RLC AM transmissions). In a transmitter-initiated approach, a transmitting side of an RLC entity (e.g., an RLC transmitter) indicates outdated packets to a receiving side of the RLC entity (e.g., an RLC receiver). The transmitting side stops retransmitting the outdated packets, and the receiving side updates state variables according to the outdated packet information received from the transmitting side. In a receiver-initiated approach, the RLC AM mode may be enhanced to enable the receiving side to indicate outdated packets to the transmitting side, and the transmitting side processes status reports associated with the outdated packets (e.g., according to legacy procedures).

When the transmitter-initiated approach is used, an RLC transmitter informs its peer entity (e.g., an RLC receiver) of SNs associated with outdated packets (e.g., PDUs), which may be referred to as outdated SNs. For example, the RLC transmitter communicates an outdated SN report to the RLC receiver that indicates the outdated SNs. In some examples, in response to the outdated SN report, the RLC receiver sends an RLC status report including ACKs and/or dummy ACKs corresponding to the outdated SNs (e.g., corresponding to PDUs indicated by the outdated SN report as being outdated). When the RLC transmitter receives the RLC status report, the RLC transmitter discards the outdated PDUs (e.g., according to legacy behavior). In other examples, the RLC transmitter may proactively discard outdated PDUs after transmitting an outdated SN report, e.g., without waiting for an RLC status report from the RLC receiver.

In either case, conventional systems implementing the transmitter-initiated approach may be susceptible to desynchronization between RLC transmission windows and RLC reception windows (e.g., due to discard of outdated PDUs at the RLC transmitter), which may result in unnecessary RLC transmissions and increase latency. Additionally, such conventional systems may lack mechanisms to combat loss of the outdated SN report and/or the RLC status report. For example, the RLC transmitter may be unaware of whether the RLC receiver has successfully received an outdated SN report indicating outdated PDUs. As a result, the RLC receiver may continue attempting to recover the outdated PDUs even though the RLC transmitter has already discarded the outdated PDUs. Further, in this approach, the maximum retransmission threshold for PDU retransmission may no longer be an effective trigger for RLF procedures (e.g., because the RLC transmitter discards outdated PDUs instead of retransmitting the outdated PDUs).

The techniques described herein provide more efficient utilization of communication resources and reduced latency by enhancing RLC AM transmitting and receiving procedures. For example, aspects of the present disclosure support configurations for retransmitting SN reports. Upon transmission of an SN report indicating SNs associated with one or more outdated RLC PDUs, an RLC transmitter activates the retransmission timer and increments a value of a retransmission counter corresponding to the retransmission threshold. If the RLC transmitter fails to receive an RLC status report from an RLC receiver prior to expiry of the retransmission timer, the RLC transmitter performs a retransmission of the outdated SN report. The RLC transmitter increments (e.g., increases) the value of the retransmission counter each time a retransmission of the SN report is performed. When the value of the retransmission counter is equal to the retransmission threshold (e.g., a value configured for the retransmission threshold), the RLC transmitter indicates (e.g., to a higher layer) that the retransmission threshold is satisfied, which may trigger an RLF procedure.

By implementing the retransmission timer and the retransmission threshold, an RLC transmitter is enabled to retransmit outdated SN reports and avoid increased latency and resource utilization associated with lost outdated SN reports. For example, by retransmitting an SN report, an RLC transmitter can increase the likelihood that a peer RLC receiver is informed of outdated PDUs and therefore does not waste time attempting to recover the outdated PDUs. Additionally, by refraining from attempting to recover the outdated PDUs, the RLC receiver can avoid redundant transmissions of outdated PDUs to a corresponding PCDP layer (e.g., outdated PDUs that would be discarded by the PCDP layer), increasing communications efficiency. Moreover, the retransmission timer and the retransmission threshold provide an upper bound on the number of retransmissions to be performed by the RLC transmitter, thereby limiting time spent on retransmission attempts and enabling the RLC transmitter to trigger RLF procedures when appropriate.

Aspects of the present disclosure are described in the context of a wireless communications system.

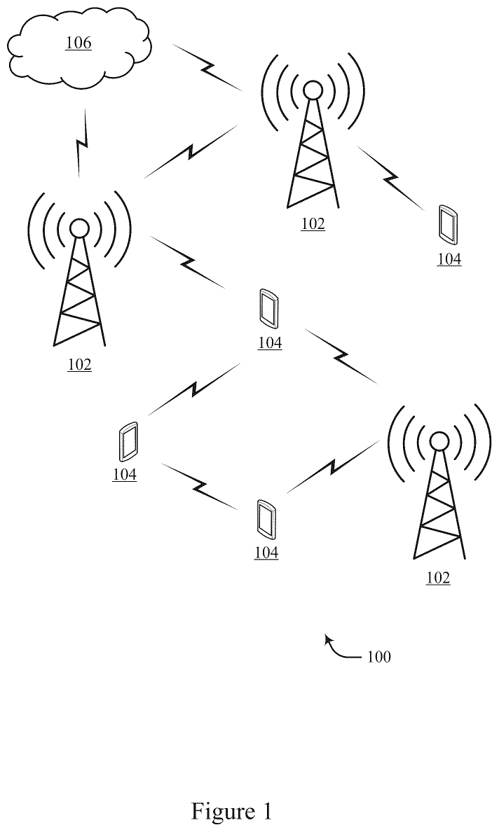

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, a network element, a network function, a network entity, a radio access network (RAN), a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. In some implementations, the first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, and fifth numerologies (i.e., μ=0, μ=1, μ=2, μ=3, μ=4) associated with respective subcarrier spacings of 15 kHz, 30 kHz, 60 kHz, 120 kHz, and 240 kHz may utilize a single slot per subframe, two slots per subframe, four slots per subframe, eight slots per subframe, and 16 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHz-52.6 GHZ), FR3 (7.125 GHZ-24.25 GHZ), FR4 (52.6 GHz-114.25 GHZ), FR4a or FR4-1 (52.6 GHz-71 GHZ), and FR5 (114.25 GHZ-300 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

A PDCP entity is a component within network architecture that is responsible for handling specific PDCP functions for a particular radio bearer. A radio bearer is a logical channel that carries data between wireless devices of the wireless communications system 100, such as NEs 102, UEs 104, and the CN 106. Each radio bearer is associated with a respective transmitting PDCP entity and a respective receiving PDCP entity which ensures proper handling and processing of data packets. For instance, a transmitting PDCP entity of a PDCP layer receives PDUs and/or SDUs from upper layers, processes the PDUs and/or SDUs, and sends them to an RLC layer. The RLC layer handles transmission over the air interface through MAC and physical (PHY) layers.

An RLC entity refers to an instance of an RLC layer that is responsible for handling specific RLC functions. A transmitting side of an RLC entity may be referred to herein as a transmitting RLC entity, an RLC transmitter, or the like. A receiving side of an RLC entity may be referred to herein as a receiving RLC entity, an RLC receiver, or the like. In some examples, such as RLC AM, a single RLC entity may perform both transmission and reception. That is, in RLC AM, the RLC entity is bidirectional, and the transmitting side communicates with a peer RLC entity's receiving side. For instance, the transmitting side receives an RLC SDU from an upper layer and assigns a next available SN to the RLC SDU. The transmitting side attaches an RLC header to the RLC SDU to form an RLC PDU and may communicate the RLC PDU to a MAC layer. The receiving side indicates packets that have been successfully received by sending an ACK (e.g., ACK_SN) and indicates lost packets by sending a NACK (e.g., a NACK_SN). The transmitting side retransmits lost packets, e.g., in response to receiving a NACK.

The wireless communications system 100 may support XR services and XR applications as described herein. XR is an umbrella term for different types of realities and refers to all real-and-virtual combined environments and human-machine interactions generated by computer technology and wearables. It includes representative forms such as AR, VR, CG, and mixed reality (MR) and the areas interpolated among them. The levels of virtuality range from partially sensory inputs to fully immersive VR. A key aspect of XR is the extension of human experiences especially relating to the senses of existence (represented by VR) and the acquisition of cognition (represented by AR).

Packet or data burst arrival times in XR may be quasi-periodic, i.e., periodic with jitter. Many XR use cases are characterized by quasi-periodic traffic (with possible jitter) with high data rate in the downlink (e.g., video streams) combined with frequent uplink (e.g., pose transmissions, control update transmissions) and/or uplink video streams. Increased jitter reduces reliability and increases latency of XR traffic, which, in turn, degrades performance and user experience. Latency requirements of XR traffic are represented as packet delay budgets (PDBs). A PDB is defined as a limited time budget for a packet to be transmitted over the air from an NE 102 to a UE 104. A PDB for a PDU set is a PSDB. For a given packet (e.g., SDU, PDU, ADU), the delay of the packet incurred via the over-the-air interface is measured from the time that the packet arrives at the NE 102 to the time that it is successfully transferred to the UE 104. If the delay is larger than the PDB configured for the packet, the packet is said to violate the PDB; otherwise, the packet is considered as successfully delivered. Additionally, a PDU set may be considered as successfully delivered only when all PDUs of the PDU set have been successfully delivered.

Violation of a PDB and/or PSDB has consequences that degrade communication performance and user experience. In real-time XR applications, for example, exceeding the PDB and/or PSDB can result in noticeable lag, buffering, playback interruptions, or a decrease in video quality. To manage transmission and reception of PDUs according to XR service requirements, a transmitting PDCP entity and a receiving PDCP entity each maintain respective timers based on a PSDB configured for a QoS flow. For example, the transmitting PDCP entity maintains one or more PDCP discard timers initiated upon reception of a PDU and/or SDU from an upper layer. The receiving PDCP entity maintains a reordering timer (e.g., t-reordering) to detect gaps of PDUs and/or SDUs in a reordering window and to ensure in-sequence delivery to higher layers.

A time duration of a PDCP discard timer reflects QoS requirements of packets belonging to a service. That is, the time duration may represent a delay budget in that the time duration corresponds to a time allowed for a transmitting PDCP entity to transmit PDUs and/or SDUs belonging to a PDU set. Accordingly, when the PDCP discard timer expires, the delay budget has been exceeded, and the corresponding PDU and/or SDU should be discarded by the transmitting PDCP entity. As an example, upon reception of a PDCP SDU from an upper layer, the transmitting PDCP entity starts the PDCP discard timer associated with the PDCP SDU. When the PDCP discard timer associated with a PDCP SDU expires, or when the successful delivery of a PDCP SDU is confirmed by a PDCP status report, the transmitting PDCP entity discards the PDCP SDU. The PDCP discard timer may be configured in the range of 0.5 ms to 1500 ms or can be switched off by choosing infinity.

The receiving PDCP entity maintains and updates the reordering window for receiving PDUs and/or SDUs based on the reordering timer. The reordering window has a defined size and range of SNs. When the receiving PDCP entity receives PDUs and/or SDUs, the receiving PDCP entity checks the SNs and/or COUNT value of the PDUs and/or SDUs. If the COUNT of a PDU and/or SDU is the next expected SN according to the reordering window, the PDU and/or SDU is considered in-sequence, and the receiving PDCP entity updates a lower bound of the reordering window (e.g., a lowest SN of the range of SNs) to the next expected SN. The receiving PDCP entity then immediately delivers the PDU and/or SDU to upper layers.

Each PDCP entity maintains a set of one or more state variables. Some state variables have an initial value set to 0 and are incremented by the responsible entity as transmission and reception occurs. For instance, a transmitting PDCP entity maintains TX_NEXT, which indicates a COUNT value of a next PDCP SDU to be transmitted. The receiving PDCP entity maintains RX_NEXT, RX_DELIV, and RX_REORD. RX_NEXT indicates the COUNT value of the next PDCP SDU expected to be received at the receiving PDCP entity. RX_DELIV indicates the COUNT value of the first PDCP SDU not delivered to upper layers, but that the receiving PDCP entity is still waiting to receive. RX_REORD indicates the COUNT value following the COUNT value associated with a PDCP data PDU that triggered a reordering procedure at the receiving PDCP entity (e.g., that triggered initiation of timer t-reordering).

In RLC AM, an RLC entity maintains a reception window for receiving PDUs and/or SDUs and a transmission window for transmitting PDUs and/or SDUs. The transmission window and the reception window each have a respective size and range of SNs. The RLC entity receives RLC PDUs within the reception window and transmits RLC PDUs within the transmission window. The RLC entity may maintain state variables and counters at the transmitting side and state variables and timers at the receiving side. At the transmitting side, the RLC entity maintains TX_NEXT, TX_NEXT_ACK, and RETX_COUNT, among other examples. TX_NEXT indicates an SN to be assigned for a next RLC SDU received from an upper layer, and may be initialized at 0 and incremented on a per-RLC SDU basis. TX_NEXT_ACK indicates a lower edge of the transmission window, which is also the next in-sequence RLC SDU for which an ACK is to be received in-sequence (e.g., TX_NEXT_ACK is incremented when the RLC entity receives an ACK for an RLC SDU with SN equal to the value of TX_NEXT_ACK). RETX_COUNT is a counter that counts a quantity of retransmissions of an RLC SDU and is incremented on a per-RLC SDU basis.

Jitter in XR traffic can impact layer 2 (L2) (e.g., PDCP layer, RLC layer, MAC layer) procedures. Due to jitter, two or more PDU sets may be interleaved upon delivery to a transmitting entity (e.g., layer) of a device, such that respective SDUs of the two or more different PDU sets are not received in order (e.g., in sequential order) at the transmitting entity. To ensure that PDU sets are transmitted within their associated PSDB, an RLC entity may implement RLC prioritization, in which transmission of PDUs and/or SDUs belonging to a PDU set for which a remaining time (e.g., of an associated PSDB) is close to zero are prioritized. These PDUs and/or SDUs may be referred to as delay-critical data. In RLC prioritization, the RLC entity may change a transmission order (referred to as changing an SN order) to deliver delay-critical PDUs and/or SDUs ahead of non-delay-critical PDUs and/or SDUs to a lower layer (e.g., a MAC layer) for transmission.

However, if a PDU and/or SDU arrives out of sequence (e.g., its COUNT is higher than expected), the receiving PDCP entity triggers timer t-reordering. As an example, a receiving PDCP entity initiates reordering when PDCP PDUs are received out of order, e.g., when a gap (e.g., an SN gap) exists in a reordering window of the receiving PDCP entity. The receiving PDCP entity temporarily stores out-of-sequence PDUs and/or SDUs in a reception buffer until the expected PDU and/or SDU (filling the gap in the reception buffer) arrives or timer t-reordering expires. The timer t-reordering runs for a predefined duration, allowing time for the missing PDU(s) and/or SDU(s) to arrive. During the timer duration, the receiving PDCP entity continues to receive and buffer PDUs and/or SDUs. If the missing PDU and/or SDU arrives within this duration, the buffered PDUs and/or SDUs are reordered and delivered in sequence to upper layers. If t-reordering expires and the missing PDU and/or SDU has not arrived, the receiving PDCP entity assumes that the missing PDU and/or SDU is lost. The receiving PDCP entity then moves the reordering window forward by updating the lower bound of the reordering window, and delivers the buffered PDUs and/or SDUs to upper layers in the order they were received, excluding the missing PDU and/or SDU. If the receiving PDCP entity receives a PDU and/or SDU associated with an SN that is outside of the range of SNs (referred to herein as being outside of the reordering window), the PDU and/or SDU is considered to be obsolete or outdated and the receiving PDCP entity discards the PDU and/or SDU.

The techniques described herein support configurations for retransmissions of SN reporting by an RLC entity of a device, such as a UE 104. For example, an NE 102 configures a threshold number of retransmissions (e.g., a retransmission threshold) for reporting one or more SNs associated with one or more RLC PDUs and a timer associated with retransmission of the reporting of the one or more SNs (e.g., a retransmission timer). The NE 102 transmits, to the UE 104, the configuration indicating the threshold number of retransmissions and the timer. The UE 104 transmits an SN report according to the configuration, where the SN report indicates the one or more SNs associated with the one or more RLC PDUs. The one or more RLC PDUs may be outdated. As described herein, an outdated PDU may be defined as a PDU for which an associated delay budget (e.g., PDB, PSDB) is exceeded and/or for which a PDCP discard timer of a corresponding PDCP SDU is expired. In some examples, the UE 104 may determine that an RLC PDU is outdated by determining whether the RLC PDU satisfies a condition, such as an associated delay budget being exceeded or a corresponding discard timer being expired.

The UE 104 transmits the SN report to a receiving entity, such as the NE 102 (e.g., an RLC entity associated with the NE 102). Based on transmitting the SN report, the UE 104 activates the timer according to the configuration and sets a value of a retransmission counter according to the configuration. The retransmission counter may correspond to or otherwise be associated with the threshold number of retransmissions. The UE 104 may be triggered to perform one or more retransmissions of the SN report, for example, upon expiry of the timer, in response to receiving a status report that indicates a NACK associated with reception of at least one RLC PDU of the one or more RLC PDUs, or the like. The UE 104 may increment the value of the retransmission counter for each performed retransmission. In some examples, if and/or when the value of the retransmission counter reaches a value equal to the threshold number of retransmissions, the UE 104 triggers an RLF procedure.

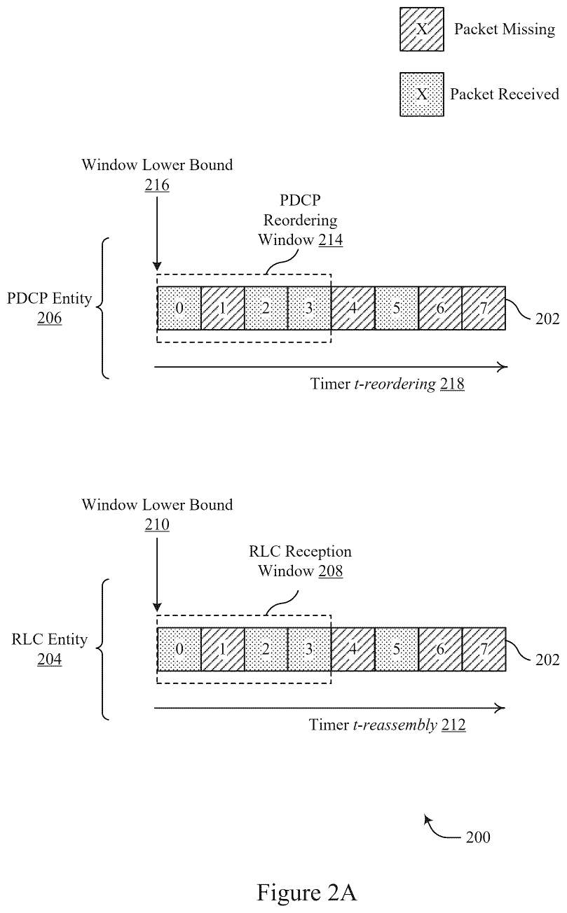

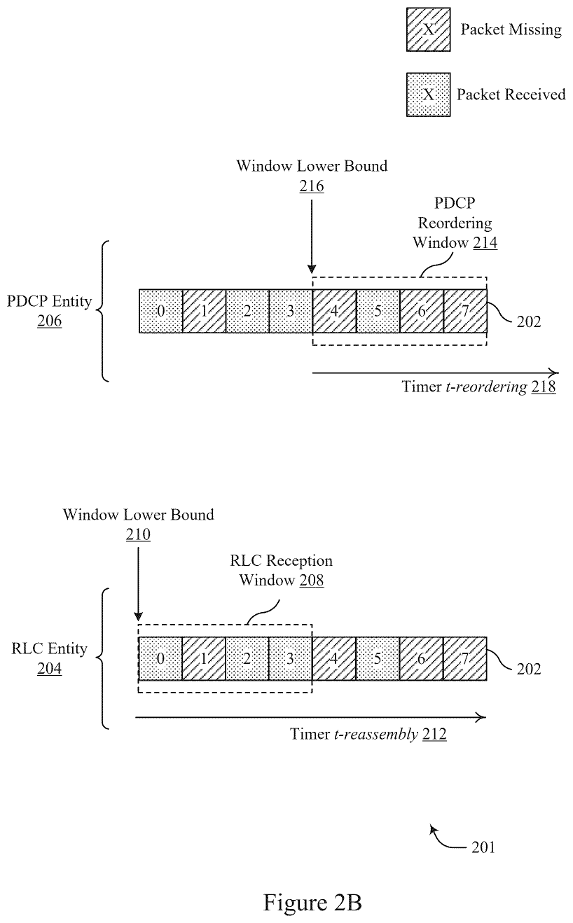

FIGS. 2A and 2B illustrate example packet reception diagrams 200 and 201, respectively, in accordance with aspects of the present disclosure. The packet reception diagrams 200 and 201 may each implement or be implemented by aspects of the wireless communications system 100 as described with reference to FIG. 1. For example, the packet reception diagrams 200 and 201 illustrate communication of packets 202 (e.g., PDUs, SDUs) at an RLC entity 204 and a PDCP entity 206 of a device, such as a UE 104. Each packet 202 is associated with an SN.

The RLC entity 204 maintains an RLC reception window 208 with a defined size and range of SNs for receiving packets 202. A lowest SN of the range of SNs defines a window lower bound 210 of the RLC reception window 208. The RLC entity 204 also maintains a timer t-reassembly 212, which is activated by the RLC entity 204 if a packet 202 is not correctly and fully received by the RLC entity 204. For example, one or more segments of the packet 202 may be missing. The PDCP entity 206 maintains a PDCP reordering window 214 with a defined size and range of SNs for receiving the packets 202. The PDCP reordering window 214 has a window lower bound 216 defined by a lowest SN of the range of SNs. The PDCP entity 206 also maintains a timer t-reordering 218, which is activated by the PDCP entity 206 if packets 202 are received out of sequence order.

When a packet 202 arrives at the PDCP entity 206, the PDCP entity 206 checks the SN and/or COUNT value of the packet 202. If the COUNT and/or SN of the packet 202 is the next expected SN as defined by the range of SNs of the PDCP reordering window 214, the packet 202 is considered to be received in sequence. The PDCP entity 206 then updates the window lower bound 216 to the next expected SN and delivers the packet 202 to a higher layer.

Because the PDCP entity 206 and the RLC entity 204 function independently, the RLC reception window 208 and the PDCP reordering window 214 can become misaligned. For instance, the PDCP entity 206 may advance the PDCP reordering window 214 by updating the window lower bound 216 even if some packets 202 are missing, e.g., if there is a gap in SNs of the packets 202. In contrast, the RLC entity 204 can only advance the RLC reception window 208 after confirming reception of a packet 202, e.g., by sending an ACK for the packet 202. Thus, the RLC entity 204 attempts to recover missing packets 202 even if the PDCP entity 206 would discard them, leading to redundant transmissions, unnecessary latency, and wasted resources.

In the example of FIG. 2A, both the PDCP reordering window 214 and the RLC reception window 208 are expecting a packet 202 having an SN of 0 (e.g., COUNT=0). The RLC entity 204 has correctly and fully received packets 202 associated with SNs 0, 2, and 3, and transmitted them to the PDCP entity 206. The RLC entity 204 has not received all segments of the packet 202 associated with SN 1 and consequently activates the timer t-reassembly 212. The PDCP entity 206 activates the timer t-reordering 218 based on receiving the packet 202 associated with SN 2 and not yet receiving the packet 202 associated with SN 1 (e.g., based on receiving SN 2 before SN 1).

FIG. 2B illustrates the RLC reception window 208 and the PDCP reordering window 214 after expiry of the timer t-reassembly 212 and the timer t-reordering 218, respectively. When the timer t-reordering 218 expires, the PDCP entity 206 transmits all packets 202 received in the PDCP reordering window 214 to a higher layer even if some packets 202 (e.g., SN 1) are missing. The PDCP entity 206 updates the window lower bound 216 of the PDCP reordering window 214 to the next SN that has not been consecutively received. For example, as illustrated in FIG. 2B, the packet 202 associated with SN 4 is the next packet that has not been consecutively received after expiry of timer t-reordering 218, and the PDCP entity 206 moves the window lower bound 216 forward to SN 4.

However, because the RLC entity 204 has not successfully received all segments of packet 202 associated with SN 1, the RLC entity 204 does not update the window lower bound 210 of the RLC reception window 208. That is, when the timer t-reassembly 212 expires, the RLC entity 204 triggers transmission of a status report. The RLC entity 204 does not update the window lower bound 210 unless the status report contains an ACK for the packet 202. Since the RLC entity 204 has not yet received the packet 202 associated with the SN 1, the RLC entity 204 attempts to recover the packet 202 by indicating a NACK in the status report and waiting to receive retransmission(s) of the packet 202. Once the packet 202 is recovered by the RLC entity 204 (e.g., once the RLC entity 204 completely and successfully receives the packet 202), the RLC entity 204 transmits the packet 202 to the PDCP entity 206 and initiates an update of the window lower bound 210. However, because the PDCP entity 206 has advanced the window lower bound 216 and is now expecting a packet 202 associated with an SN 4, the PDCP entity 206 will discard the packet 202 associated with SN 1.

Decoupling the PDCP reordering window 214 from the timer t-reordering 218 may avoid misalignment of the PDCP reordering window 214 and the RLC reception window 208 by enabling the PDCP entity 206 to advance the PDCP reordering window 214 automatically upon successful reception of a packet 202. In some examples, this can be achieved by setting a value (e.g., a time duration) of the timer t-reordering 218 to infinity, such that it never expires. Accordingly, the PDCP entity 206 is enabled to transmit all packets 202 received within the PDCP reordering window 214 to higher layers immediately (e.g., provided header decompression is performed, if not already decompressed) after reception if outOfOrderDelivery is configured. If outOfOrderDelivery is not configured, the PDCP entity 206 updates the window lower bound 216 of the PDCP reordering window 214 only when it receives a packet 202 with a COUNT value consecutive to that of the RX_DELIV COUNT value. In other examples, decoupling the PDCP reordering window 214 from the timer t-reordering 218 can be achieved by removing the timer t-reordering 218, e.g., RRC no longer configures the timer t-reordering 218 for the PDCP entity 206 and the PDCP reordering window 214 only advances based on reception of packets 202 and whether outOfOrderDelivery is configured.

Alternatively, to avoid misalignment, the timer t-reordering 218 can be configured (e.g., RRC configured) with a non-infinity value, but does not affect the window lower bound 216 of the PDCP reordering window 214. In this example, the timer t-reordering 218 is only configured if outOfOrderDelivery is configured. The timer t-reordering 218 dictates the time allowed by the PDCP entity 206 to deliver received packets 202 in order. The timer t-reordering 218 is started when a packet 202 is received by the PDCP entity 206 out of sequence (e.g., out of order). When the timer t-reordering 218 expires, the PDCP entity 206 delivers all packets 202 received prior to expiry of the timer t-reordering 218, e.g., regardless of whether the packets 202 are in order or not. The PDCP entity 206 then waits until it recovers any missing packets 202 before advancing the window lower bound 216 of the PDCP reordering window 214 and restarting t-Reordering.

Decoupling the PDCP reordering window 214 from the timer t-reordering 218 may synchronize the PDCP reordering window 214 and the RLC reception window 208 of the PDCP entity 206 and the RLC entity 204, respectively, but may require additional communication resources to recover all packets 202 expected to be received and may increase overall latency on the user plane. Additionally, such methods may not be useful for packets 202 with relatively small PDBs/PSDBs, as the PDCP entity 206 may take more time to recover all packets 202 that it expects to receive (e.g., unless an RRC reestablishment procedure is performed due to RLF).

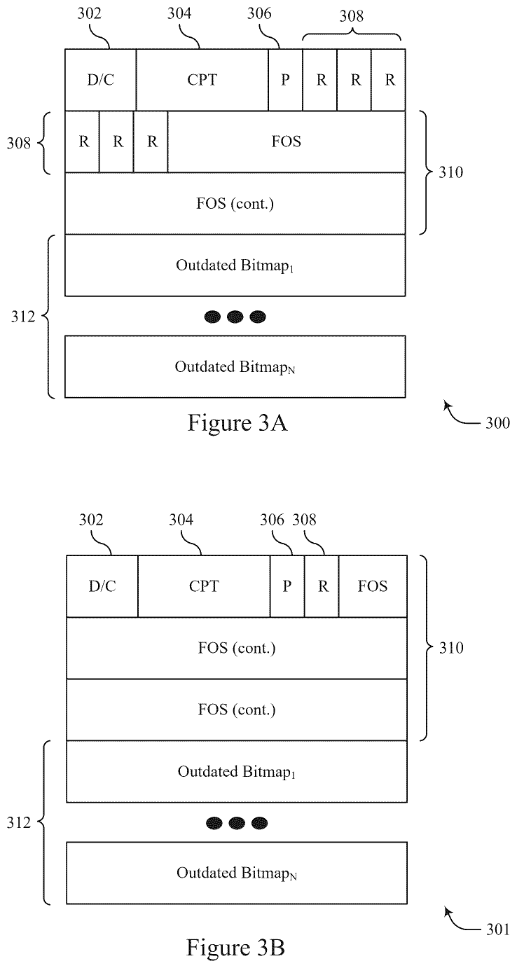

Aspects of the present disclosure include solutions that are more optimal in terms of resource utilization and latency to make user place functionality as efficient as possible for services, such as XR, that are extremely delay-sensitive. As described in greater detail with reference to FIGS. 3A and 3B, the described techniques enable seamless resolution of window management for PDCP and RLC entities, while improving efficiency in resource utilization and reducing latency. For example, according to the techniques described herein, the RLC entity 204 may receive an SN report indicating one or more SNs associated with one or more packets 202 that satisfy a condition and are therefore outdated, which may be referred to as an outdated SN report. The condition may be that an associated PDB/PSDB is exceeded and/or that a PDCP discard timer of a corresponding PDCP SDU is expired. Upon reception of the SN report, the RLC entity 204 may discard any packets 202 corresponding to the indicated one or more SNs, e.g., instead of attempting to recover the packets 202, thereby reducing unnecessary transmissions.

FIGS. 3A and 3B illustrates example RLC control PDUs 300 and 301, respectively, in accordance with aspects of the present disclosure. The RLC control PDUs 300 and 301 may implement or be implemented by aspects of the wireless communications system 100. For example, the RLC control PDUs 300 and 301 may include or be examples of SN reports (e.g., outdated SN reports) transmitted and/or received by a UE 104 and/or an NE 102. As described herein, an SN report indicates one or more SNs associated with one or more outdated RLC PDUs.

The RLC control PDU 300 illustrated in FIG. 3A is an example of an SN report for indicating 12 bit SNs. The RLC control PDU 301 illustrated in FIG. 3B is an example of an SN report for indicating 18 bit SNs. The RLC control PDU 300 and the RLC control PDU 301 each include, within a respective header, a D/C field 302, a CPT field 304, a poll bit 306, and a set of reserved bit fields 308. Additionally, the RLC control PDU 300 and the RLC control PDU 301 each include a respective first outdated SN (FOS) field 310 and respective a set of outdated bitmaps 312.

The D/C field 302 is one bit in length and indicates whether an RLC PDU is an RLC control PDU or an RLC data PDU/SDU. The CPT field 304 indicates a type of RLC control PDU 300, such as an RLC outdated SN report PDU. The poll bit 306 is a one-bit indication having a value that indicates whether a receiving entity is to transmit a status report indicating whether the receiving entity successfully received the one or more outdated RLC PDUs (e.g., ACKs/NACKs for each RLC PDU of the one or more outdated RLC PDUs). For example, a value of 0 of the poll bit indicates that the receiving entity is to refrain from transmitting a status report, while a value of 1 of the poll bit indicates that the receiving entity is to transmit the status report. The FOS field 310 indicates a smallest (e.g., lowest in value) SN value among the one or more SNs associated with the one or more outdated RLC PDUs. The set of outdated bitmaps 312 indicates which RLC PDUs and/or SDUs are outdated and which RLC PDUs/SDUs are not outdated. The bit position of the N^{th} bit in an outdated bitmap 312 is N. For example, the bit position of the first bit in an outdated bitmap 312 is 1.

An RLC entity of a transmitting device, such as the UE 104, informs a peer RLC entity of a receiving device, such as the NE 102, of outdated RLC PDUs using an SN report, which may include or be an example of the RLC control PDU 300 and/or the RLC control PDU 301. An “outdated” RLC PDU is to be understood as an RLC PDU for which an associated delay budget is exceeded, such that the outdated RLC PDU is no longer of use for the application layer. As an example, an outdated RLC PDU may be defined as an RLC PDU for which a corresponding PDCP SDU and/or PDCP PDU has already been discarded, e.g., an associated PDCP discardTimer has already expired. The UE 104 determines whether an RLC PDU is outdated by determining whether the RLC PDU satisfies a condition. For example, the UE 104 determines that one or more RLC PDUs satisfy the condition if a PDCP discard timer of a corresponding PDCP SDU is expired, or if an associated PDB and/or PSDB is exceeded. Based on the determining, the UE 104 transmits the SN report indicating one or more SNs associated with the one or more RLC PDUs.

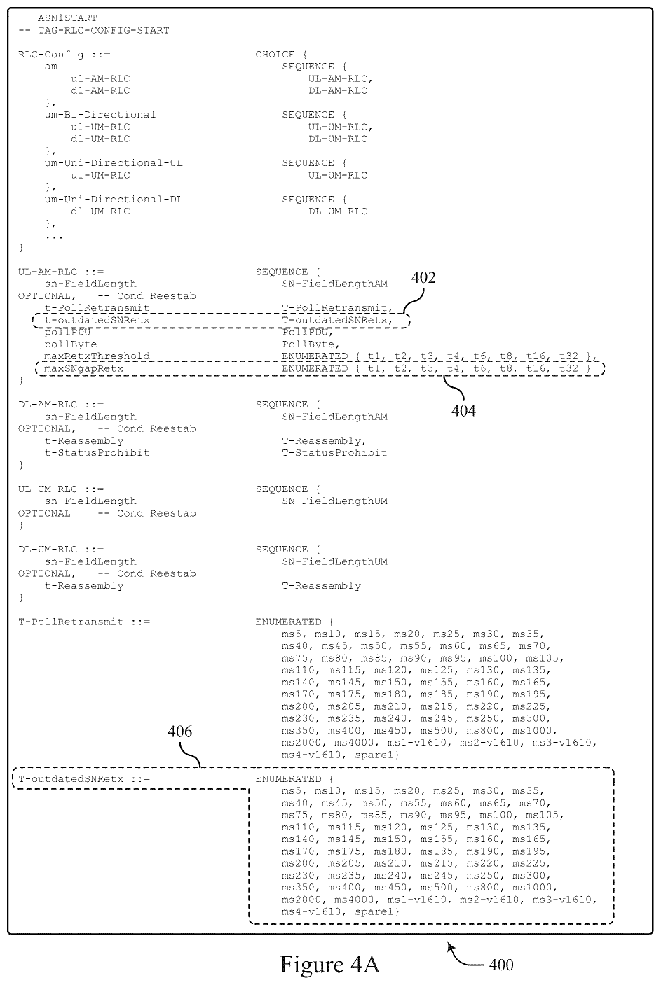

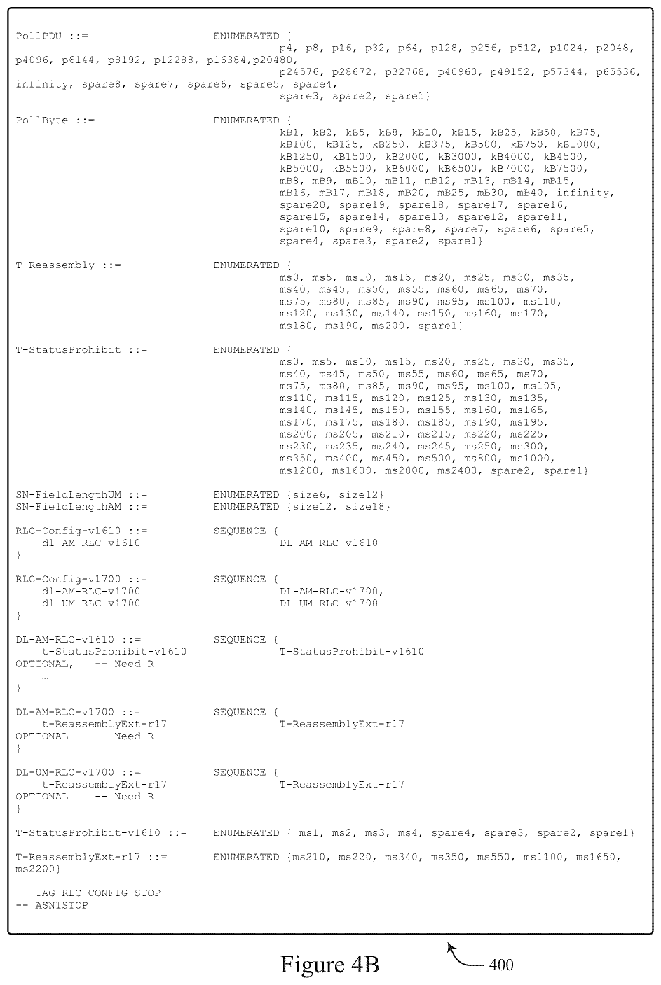

In implementations, the UE 104 receives a configuration (e.g., an RRC message) from the NE 102 that indicates a retransmission threshold (e.g., maxSNgapRetx) and a retransmission timer as described with reference to FIGS. 4A and 4B and may transmit the SN report according to the configuration. The retransmission threshold may be configured for an RLC entity, such as the RLC entity associated with the UE 104, and the UE 104 maintains the retransmission threshold for every outdated SN report transmitted to a receiving entity. The retransmission threshold represents a threshold number (e.g., quantity) of retransmissions for reporting SNs associated with one or more RLC PDUs. That is, the retransmission threshold may be defined as a maximum number of times that the UE 104 may (re) transmit the SN report. Additionally, the UE 104 maintains a retransmission counter (e.g., SNGapRETX_COUNT) to count every transmission (e.g., every initial transmission and/or retransmission) of an SN report.

Transmission of the SN report triggers the UE 104 (e.g., the RLC entity associated with the UE 104) to activate the retransmission timer and to set a value of a retransmission counter corresponding to the retransmission threshold. The retransmission counter may be maintained on a per SN report basis or on a per outdated PDU basis. In an example of a retransmission counter being maintained on a per SN report basis, the UE 104 sets a value of the retransmission counter to 0 when it initially transmits an SN report. The UE 104 increases (e.g., increments) the value of the retransmission counter for each retransmission of the SN report. Specifically, the UE 104 increases the value of the retransmission counter to 1 when the UE 104 retransmits the same SN report for the first time (e.g., as a first retransmission of the SN report), and increases the value of the counter to 2 when the UE 104 retransmits the same SN report for the second time (e.g., as a second retransmission of the SN report), and so forth. The retransmission counter may take values from 0 to maxSNgapRetx (0 and maxSNgapRetx inclusive).

In other implementations, the retransmission counter is maintained on a per outdated PDU basis, and the UE 104 increases (e.g., increments) the value of the retransmission counter when all or some RLC PDUs previously indicated as outdated in an SN report are indicated as outdated again in a new (e.g., different) SN report. That is, the UE 104 increases the value of the retransmission counter by 1 for each instance that one or more RLC PDUs are indicated as outdated in distinct SN reports. In yet other implementations, the UE 104 sets the value of the retransmission counter to 0 for an RLC PDU when the RLC PDU is first (e.g., initially) indicated as outdated in an SN report, and increments (e.g., increases) the value of the retransmission counter each time that the RLC PDU (or a segment of the RLC PDU) is indicated again (e.g., reindicated) as outdated in a retransmission of the SN report or in a different SN report. In any case, the UE 104 increments (e.g., increases) the value of the retransmission counter until the value of the retransmission counter is equal to the retransmission threshold (e.g., maxSNgapRetx). The number (e.g., quantity) of retransmissions allowed for the UE 104 is limited by the retransmission threshold. When the value of the retransmission counter is equal to the threshold, the UE 104 is triggered to indicate (e.g., to a higher layer) that a maximum retransmission has been reached, which may further trigger an RLF procedure to be performed between the UE 104 and the NE 102.

In response to receiving the SN report that indicates the one or more outdated RLC PDUs, the NE 102 may transmit, to the UE 104, a status report indicating whether the one or more outdated RLC PDUs were successfully received by the NE 102. The status report may indicate, for each outdated RLC PDU, a NACK, an ACK, or a dummy ACK. In some cases, the NE 102 may transmit the status report after expiry of a timer t-reassembly. In some examples, the UE 104 retransmits the SN report in response to reception of a NACK for one or more of the outdated RLC PDUs. In implementations, the UE 104 may include the poll bit 306 in the SN report to avoid waiting (e.g., for the duration of t-reassembly) for the status report. In some cases, the UE 104 discards the outdated RLC PDUs upon reception of the status report. Alternatively, the UE 104 discards the outdated RLC PDUs immediately after transmitting the SN report indicating the outdated RLC PDUs, e.g., without waiting for the status report.

In implementations, the UE 104 maintains a retransmission timer (e.g., t-oudatedSNRetx) that the UE 104 activates upon transmission of an SN report. The retransmission timer is configured by the network (e.g., by the NE 102 via RRC signaling). Expiry of the retransmission timer may trigger the UE 104 to retransmit the SN report associated with the retransmission timer. In some examples, the retransmission timer is set (e.g., via the configuration) to a value equivalent to an RTT for transmit and receive communications between the UE 104 and the NE 102. The UE 104 stops the retransmission timer when the RLC entity receives a status report from the NE 102 indicating successful reception of the RLC PDUs indicated as outdated in the SN report, e.g., indicating a respective ACK or a dummy ACK for each RLC PDU indicated as outdated in the SN report. In other examples, such as when the UE 104 includes the poll bit 306 in the SN report, the retransmission timer is set to a value equivalent to the RTT plus a value equivalent to a duration of the timer t-Reassembly, e.g., to account for sufficient time for the NE 102 to attempt to receive the outdated PDUs.

FIGS. 4A and 4B illustrate an example RLC configuration IE 400 in accordance with aspects of the present disclosure. The RLC configuration IE 400 may implement or be implemented by aspects of the wireless communications system 100. For example, the RLC configuration IE 400 may be included as part of a configuration message (e.g., RLC-Config) transmitted, by an NE 102, to a UE 104 to configure RLC (e.g., an RLC entity) of the UE 104 as described herein.

The RLC configuration IE 400 is used to set configurable RLC parameters, such as a threshold for retransmitting RLC data PDUs (e.g., maxRetxThreshold), a threshold for retransmitting SN reports (e.g., maxSNgapRetx), a retransmission timer for transmitting SN reports (e.g., t-outdatedSNRetx), a timer t-reassembly, and the like. For example, the RLC configuration IE 400 includes an indication 402 indicating whether the timer t-outdatedSNRetx is configured for RLC of the UE 104. The RLC configuration IE 400 also includes an indication 404 indicating the threshold for retransmitting SN reports maxSNgapRetx, as well as a configuration 406 indicating a timer duration (in ms) for the timer t-outdatedSNRetx.

The threshold for retransmitting RLC PDUs may be defined as a maximum number (e.g., quantity) of retransmissions of one or more RLC data PDUs. In contrast and as described herein, the threshold for retransmitting SN reports may defined as a threshold number (e.g., quantity) of retransmissions for reporting outdated SNs, e.g., as part of an RLC control PDU as described with reference to FIGS. 3A and 3B. According to the techniques described herein, the NE 102 configures the threshold for retransmitting SN reports maxSNgapRetx and the timer t-outdatedSNRetx. The NE 102 transmits the RLC configuration IE 400 to the UE 104. Upon transmission of an SN report indicating one or more SNs associated with one or more RLC PDUs (e.g., one or more outdated RLC PDUs), the UE 104 activates the timer t-outdatedSNRetx according to the configuration, e.g., according to the indication 402 and the configuration 406. The UE 104 sets a value of a retransmission counter corresponding to the threshold maxSNgapRetx and increments the value on a per-SN report retransmission basis or a per-PDU basis as described herein. In some cases, the UE 104 triggers an RLF procedure with the NE 102 if and when the value of the retransmission value is equal to the threshold maxSNgapRetx.

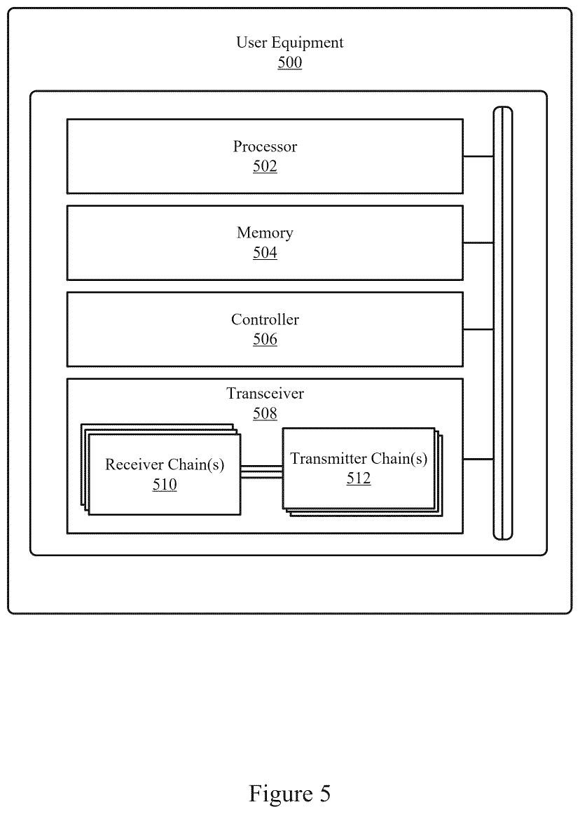

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to or operable to support a means for receiving a configuration associated with RLC of the UE 500, where the configuration indicates a threshold number of retransmissions for reporting one or more SNs associated with one or more RLC PDUs and a timer associated with retransmission of the reporting of the one or more SNs associated with the one or more RLC PDUs; transmitting an SN report that indicates the one or more SNs associated with the one or more RLC PDUs; activating the timer according to the configuration and in response to the transmitted SN report; and setting a value of a retransmission counter according to the configuration and in response to the transmitted SN report.

Additionally, the UE 500 may be configured to support any one or combination of performing one or more retransmissions of the SN report; and incrementing the value of the retransmission counter for each of the one or more performed retransmissions of the SN report. Performing a retransmission of the SN report in response to an expiry of the timer. Receiving a status report that indicates a NACK associated with reception of at least one RLC PDU of the one or more RLC PDUs; and performing a retransmission of the SN report based on the received status report. The threshold number of retransmissions is satisfied based on the value of the retransmission counter being equal to the threshold number of retransmissions. To set the value of the retransmission counter, the method further comprises setting the value of the retransmission counter to zero based on one or more RLC PDUs associated with the one or more SNs being indicated in the SN report or satisfying a condition, where the condition comprises a PDB; and incrementing the value of the retransmission counter for each instance that the one or more RLC PDUs associated with the one or more SNs are indicated in a retransmission of the SN report or a different SN report.

Additionally, or alternatively, the UE 500 may be configured to support any one or combination of indicating that the threshold number of retransmissions is satisfied based on the value of the retransmission counter being equal to the threshold number of retransmissions. Receiving a status report indicating successful reception of the one or more RLC PDUs; and stopping the timer based on receiving the status report. Transmitting, as part of the SN report, a poll bit, where a first value of the poll bit indicates that a receiving entity is to refrain from transmitting a status report associated with the one or more RLC PDUs and a second value of the poll bit indicates that the receiving entity is to transmit the status report associated with the one or more RLC PDUs. The configuration indicates a time duration for the timer, the time duration corresponding to a round trip time for transmit and receive communications between the RLC of the UE 500 and a receiving entity. The configuration indicates a time duration for the timer, the time duration corresponding to a round trip time for transmit and receive communications between the RLC of the UE 500 and a receiving entity plus a reassembly timer duration associated with the receiving entity. The one or more RLC PDUs comprise RLC PDUs for which an associated delay budget is exceeded. Determining that an RLC PDU of the one or more RLC PDUs satisfies a condition when a PDCP discard timer of a corresponding PDCP SDU is expired. Triggering a RLF procedure based on the threshold number of retransmissions being satisfied.

Additionally, or alternatively, the UE 500 may support at least one memory (e.g., the memory 504) and at least one processor (e.g., the processor 502) coupled with the at least one memory and configured to cause the UE 500 to receive a configuration associated with RLC of the UE 500, where the configuration indicates a threshold number of retransmissions for reporting one or more SNs associated with one or more RLC PDUs and a timer associated with retransmission of the reporting of the one or more SNs associated with the one or more RLC PDUs; transmit an SN report that indicates the one or more SNs associated with the one or more RLC PDUs; activate the timer according to the configuration and in response to the transmitted SN report; and set a value of a retransmission counter according to the configuration and in response to the transmitted SN report.

Additionally, the UE 500 may be configured to support any one or combination of the at least one processor is configured to cause the UE 500 to perform one or more retransmissions of the SN report, and increment the value of the retransmission counter for each of the one or more performed retransmissions of the SN report. The at least one processor is configured to cause the UE 500 to perform a retransmission of the SN report in response to an expiry of the timer. The at least one processor is configured to cause the UE 500 to receive a status report that indicates a NACK associated with reception of at least one RLC PDU of the one or more RLC PDUs, and perform a retransmission of the SN report based on the received status report. The threshold number of retransmissions is satisfied based on the value of the retransmission counter being equal to the threshold number of retransmissions. To set the value of the retransmission counter, the at least one processor is configured to cause the UE 500 to set the value of the retransmission counter to zero based on one or more RLC PDUs associated with the one or more SNs being indicated in the SN report or satisfying a condition, where the condition comprises a PDB, and increment the value of the retransmission counter for each instance that the one or more RLC PDUs associated with the one or more SNs are indicated in a retransmission of the SN report or a different SN report.

Additionally, or alternatively, the at least one processor is configured to cause the UE 500 to indicate that the threshold number of retransmissions is satisfied based on the value of the retransmission counter being equal to the threshold number of retransmissions. The at least one processor is configured to cause the UE 500 to receive a status report indicating successful reception of the one or more RLC PDUs, and stop the timer based on receiving the status report. The at least one processor is configured to cause the UE 500 to transmit, as part of the SN report, a poll bit, where a first value of the poll bit indicates that a receiving entity is to refrain from transmitting a status report associated with the one or more RLC PDUs and a second value of the poll bit indicates that the receiving entity is to transmit the status report associated with the one or more RLC PDUs. The configuration indicates a time duration for the timer, the time duration corresponding to a round trip time for transmit and receive communications between the RLC of the UE 500 and a receiving entity. The configuration indicates a time duration for the timer, the time duration corresponding to a round trip time for transmit and receive communications between the RLC of the UE 500 and a receiving entity plus a reassembly timer duration associated with the receiving entity. The one or more RLC PDUs comprise RLC PDUs for which an associated delay budget is exceeded. The at least one processor is configured to cause the UE 500 to determine that an RLC PDU of the one or more RLC PDUs satisfies a condition when a PDCP discard timer of a corresponding PDCP SDU is expired. The at least one processor is configured to cause the UE 500 to trigger a RLF procedure based on the threshold number of retransmissions being satisfied.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

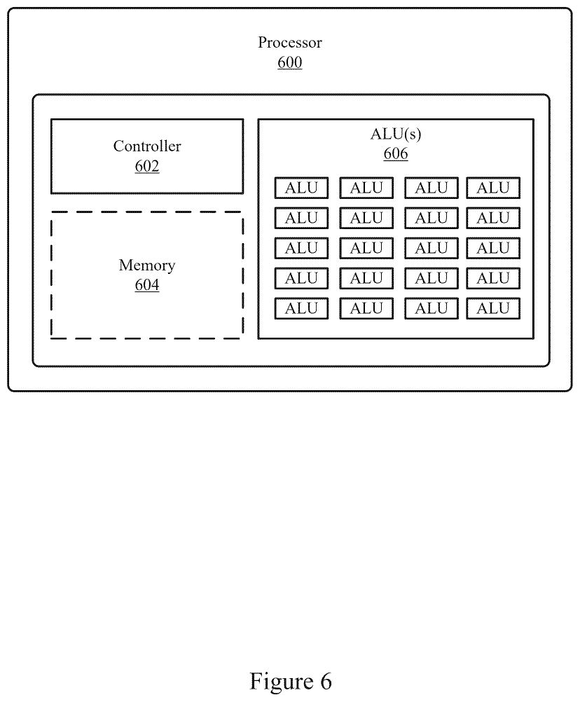

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor 600 to receive a configuration message associated with RLC of a UE, where the configuration indicates a threshold number of retransmissions for reporting one or more SNs associated with one or more RLC PDUs and a timer associated with retransmission of the reporting of the one or more SNs associated with the one or more RLC PDUs, transmit an SN report that indicates the one or more SNs associated with the one or more RLC PDUs, activate the timer according to the configuration and in response to the transmitted SN report, and set a value of a retransmission counter according to the configuration and in response to the transmitted SN report.

Additionally, the processor 600 may be configured to or operable to support any one or combination of the at least one controller is configured to cause the processor 600 to perform one or more retransmissions of the SN report, and increment the value of the retransmission counter for each of the one or more performed retransmissions of the SN report. The at least one controller is configured to cause the processor 600 to perform a retransmission of the SN report in response to an expiry of the timer. The at least one controller is configured to cause the processor 600 to cause the UE to receive a status report that indicates a NACK associated with reception of at least one RLC PDU of the one or more RLC PDUs, and perform a retransmission of the SN report based on the received status report. The threshold number of retransmissions is satisfied based on the value of the retransmission counter being equal to the threshold number of retransmissions. To set the value of the retransmission counter, the at least one controller is configured to cause the processor 600 to set the value of the retransmission counter to zero based on one or more RLC PDUs associated with the one or more SNs being indicated in the SN report or satisfying a condition, where the condition comprises a PDB, and increment the value of the retransmission counter for each instance that the one or more RLC PDUs associated with the one or more SNs are indicated in a retransmission of the SN report or a different SN report.

Additionally, or alternatively, the at least one controller is configured to cause the processor 600 to cause the UE to indicate that the threshold number of retransmissions is satisfied based on the value of the retransmission counter being equal to the threshold number of retransmissions. The at least one controller is configured to cause the processor 600 to cause the UE to receive a status report indicating successful reception of the one or more RLC PDUs, and stop the timer based on receiving the status report. The at least one controller is configured to cause the processor 600 to cause the UE to transmit, as part of the SN report, a poll bit, where a first value of the poll bit indicates that a receiving entity is to refrain from transmitting a status report associated with the one or more RLC PDUs and a second value of the poll bit indicates that the receiving entity is to transmit the status report associated with the one or more RLC PDUs. The configuration indicates a time duration for the timer, the time duration corresponding to a round trip time for transmit and receive communications between the RLC of the UE and a receiving entity. The configuration indicates a time duration for the timer, the time duration corresponding to a round trip time for transmit and receive communications between the RLC of the UE and a receiving entity plus a reassembly timer duration associated with the receiving entity. The one or more RLC PDUs comprise RLC PDUs for which an associated delay budget is exceeded. The at least one controller is configured to cause the processor 600 to determine that an RLC PDU of the one or more RLC PDUs satisfies a condition when a PDCP discard timer of a corresponding PDCP SDU is expired. The at least one controller is configured to cause the processor 600 to trigger an RLF procedure based on the threshold number of retransmissions being satisfied.

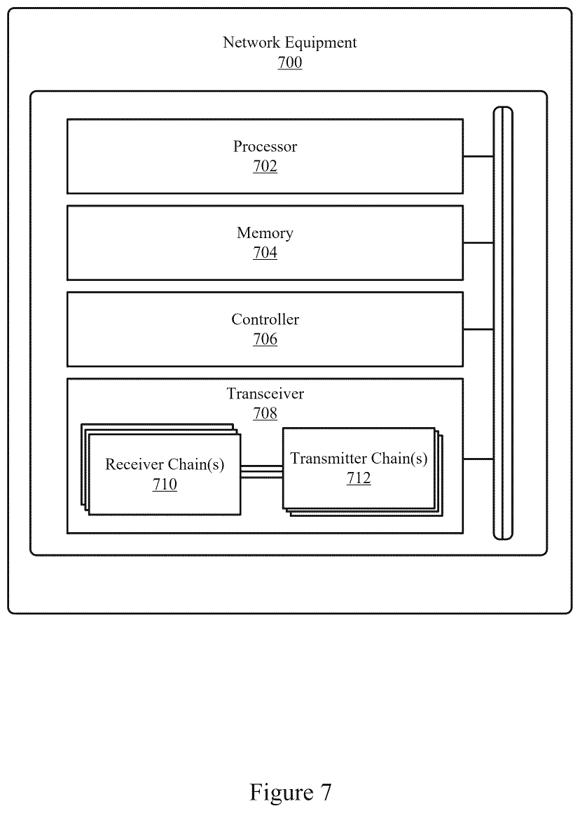

FIG. 7 illustrates an example of an NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to or operable to support a means for configuring, for RLC associated with a UE, a threshold number of retransmissions for reporting one or more SNs associated with one or more RLC PDUs and a timer associated with retransmission of the reporting of the one or more SNs associated with the one or more RLC PDUs, and transmitting, to the UE, a configuration indicating the threshold number of retransmissions and the timer.

Additionally, the NE 700 may be configured to or operable to support any one or combination of the method comprising receiving an SN report that indicates the one or more SNs associated with the one or more RLC PDUs in accordance with the configuration. Transmitting a status report that indicates a NACK associated with reception of at least one RLC PDU of the one or more RLC PDUs, and receiving a retransmission of the SN report based on the transmitted status report. Transmitting, in response to receiving the SN report, a status report indicating successful reception of the one or more RLC PDUs. Receiving, as part of the SN report, a poll bit, where a first value of the poll bit indicates that the NE 700 is to refrain from transmitting a status report associated with the one or more RLC PDUs and a second value of the poll bit indicates that the NE 700 is to transmit the status report associated with the one or more RLC PDUs. The configuration indicates a time duration for the timer, the time duration corresponding to a round trip time for transmit and receive communications between the RLC of the UE and the NE 700. The configuration indicates a time duration for the timer, the time duration corresponding to a round trip time for transmit and receive communications between the RLC of the UE and the NE 700 plus a reassembly timer duration associated with the NE 700. The one or more RLC PDUs comprise RLC PDUs for which an associated delay budget is exceeded.

Additionally, or alternatively, the NE 700 may support at least one memory (e.g., the memory 704) and at least one processor (e.g., the processor 702) coupled with the at least one memory and configured to cause the NE 700 to configure, for RLC associated with a UE, a threshold number of retransmissions for reporting one or more SNs associated with one or more RLC PDUs and a timer associated with retransmission of the reporting of the one or more SNs associated with the one or more RLC PDUs; and transmit, to the UE, a configuration indicating the threshold number of retransmissions and the timer.

Additionally, the NE 700 may be configured to support any one or combination of the at least one processor is configured to cause the NE 700 to receive an SN report that indicates the one or more SNs associated with the one or more RLC PDUs in accordance with the configuration. The at least one processor is configured to cause the NE 700 to transmit a status report that indicates a NACK associated with reception of at least one RLC PDU of the one or more RLC PDUs, and receive a retransmission of the SN report based on the transmitted status report. The at least one processor is configured to cause the NE 700 to transmit, in response to receiving the SN report, a status report indicating successful reception of the one or more RLC PDUs. The at least one processor is configured to cause the NE 700 to receive, as part of the SN report, a poll bit, where a first value of the poll bit indicates that the NE 700 is to refrain from transmitting a status report associated with the one or more RLC PDUs and a second value of the poll bit indicates that the NE 700 is to transmit the status report associated with the one or more RLC PDUs. The configuration indicates a time duration for the timer, the time duration corresponding to a round trip time for transmit and receive communications between the RLC of the UE and the NE 700. The configuration indicates a time duration for the timer, the time duration corresponding to a round trip time for transmit and receive communications between the RLC of the UE and the NE 700 plus a reassembly timer duration associated with the NE 700. The one or more RLC PDUs comprise RLC PDUs for which an associated delay budget is exceeded.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

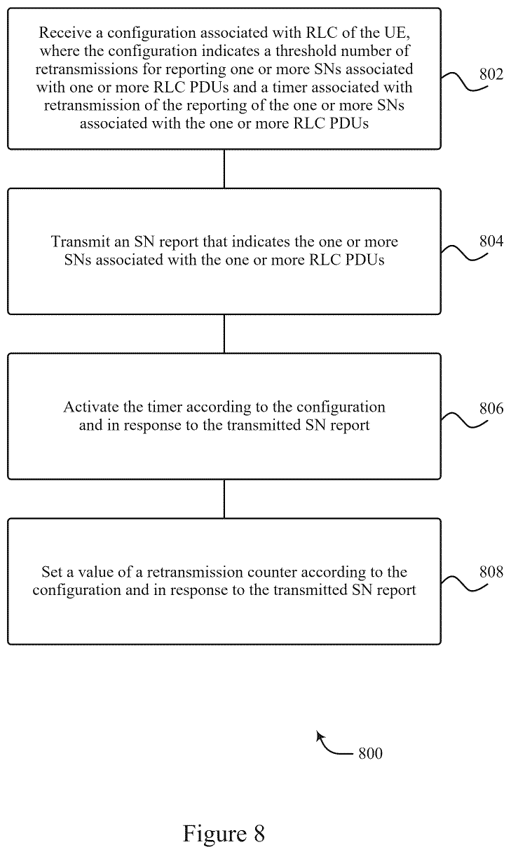

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include receiving a configuration associated with RLC of the UE, where the configuration indicates a threshold number of retransmissions for reporting one or more SNs associated with one or more RLC PDUs and a timer associated with retransmission of the reporting of the one or more SNs associated with the one or more RLC PDUs. The operations of 802 may be performed in accordance with examples as described herein. In some implementations, aspects of the operations of 802 may be performed by a UE as described with reference to FIG. 5.

At 804, the method may include transmitting an SN report that indicates the one or more SNs associated with the one or more RLC PDUs. The operations of 804 may be performed in accordance with examples as described herein. In some implementations, aspects of the operations of 804 may be performed by a UE as described with reference to FIG. 5.

At 806, the method may include activating the timer according to the configuration and in response to the transmitted SN report. The operations of 806 may be performed in accordance with examples as described herein. In some implementations, aspects of the operations of 806 may be performed a UE as described with reference to FIG. 5.

At 808, the method may include setting a value of a retransmission counter according to the configuration and in response to the transmitted SN report. The operations of 808 may be performed in accordance with examples as described herein. In some implementations, aspects of the operations of 808 may be performed a UE as described with reference to FIG. 5.

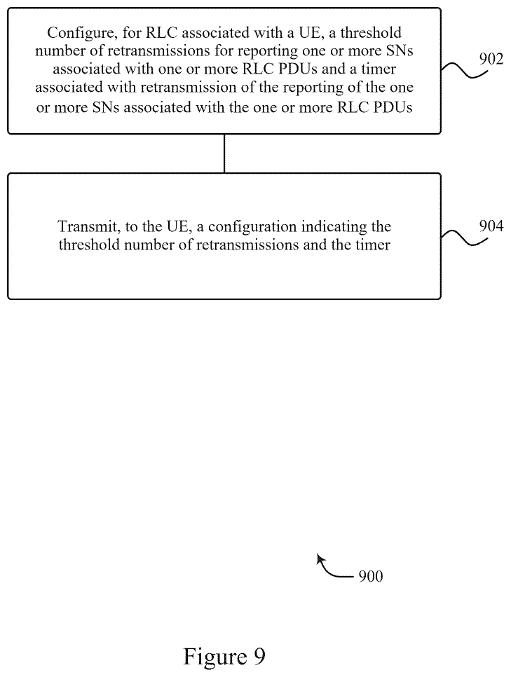

FIG. 9 illustrates a flowchart of a method 900 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include configuring, for RLC associated with a UE, a threshold number of retransmissions for reporting one or more SNs associated with one or more RLC PDUs and a timer associated with retransmission of the reporting of the one or more SNs associated with the one or more RLC PDUs. The operations of 902 may be performed in accordance with examples as described herein. In some implementations, aspects of the operations of 902 may be performed by an NE as described with reference to FIG. 7.

At 904, the method may include transmitting, to the UE, a configuration indicating the threshold number of retransmissions and the timer. The operations of 904 may be performed in accordance with examples as described herein. In some implementations, aspects of the operations of 904 may be performed by an NE as described with reference to FIG. 7.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive a configuration associated with radio link control (RLC) of the UE, wherein the configuration indicates a threshold number of retransmissions for reporting one or more sequence numbers (SNs) associated with one or more RLC protocol data units (PDUs) and a timer associated with retransmission of the reporting of the one or more SNs associated with the one or more RLC PDUs;
transmit an SN report that indicates the one or more SNs associated with the one or more RLC PDUs;
activate the timer according to the configuration and in response to the transmitted SN report; and
set a value of a retransmission counter according to the configuration and in response to the transmitted SN report.

2. The UE of claim 1, wherein the at least one processor is configured to cause the UE to:
perform one or more retransmissions of the SN report; and
increment the value of the retransmission counter for each of the one or more performed retransmissions of the SN report.

3. The UE of claim 2, wherein the at least one processor is configured to cause the UE to perform a retransmission of the SN report in response to an expiry of the timer.

4. The UE of claim 2, wherein the at least one processor is configured to cause the UE to:
receive a status report that indicates a negative acknowledgement (NACK) associated with reception of at least one RLC PDU of the one or more RLC PDUs; and
perform a retransmission of the SN report based at least in part on the received status report.

5. The UE of claim 2, wherein the threshold number of retransmissions is satisfied based at least in part on the value of the retransmission counter being equal to the threshold number of retransmissions.

6. The UE of claim 1, wherein, to set the value of the retransmission counter, the at least one processor is configured to cause the UE to:
set the value of the retransmission counter to zero based at least in part on one or more RLC PDUs associated with the one or more SNs being indicated in the SN report or satisfying a condition, wherein the condition comprises a packet delay budget (PDB); and
increment the value of the retransmission counter for each instance that the one or more RLC PDUs associated with the one or more SNs are indicated in a retransmission of the SN report or a different SN report.

7. The UE of claim 6, wherein the at least one processor is configured to cause the UE to indicate that the threshold number of retransmissions is satisfied based at least in part on the value of the retransmission counter being equal to the threshold number of retransmissions.

8. The UE of claim 1, wherein the at least one processor is configured to cause the UE to:
receive a status report indicating successful reception of the one or more RLC PDUs; and
stop the timer based at least in part on receiving the status report.

9. The UE of claim 1, wherein the at least one processor is configured to cause the UE to transmit, as part of the SN report, a poll bit, wherein a first value of the poll bit indicates that a receiving entity is to refrain from transmitting a status report associated with the one or more RLC PDUs and a second value of the poll bit indicates that the receiving entity is to transmit the status report associated with the one or more RLC PDUs.

10. The UE of claim 1, wherein the configuration indicates a time duration for the timer, the time duration corresponding to a round trip time for transmit and receive communications between the RLC of the UE and a receiving entity.

11. The UE of claim 1, wherein the configuration indicates a time duration for the timer, the time duration corresponding to a round trip time for transmit and receive communications between the RLC of the UE and a receiving entity plus a reassembly timer duration associated with the receiving entity.

12. The UE of claim 1, wherein the one or more RLC PDUs comprise RLC PDUs for which an associated delay budget is exceeded.

13. The UE of claim 1, wherein the at least one processor is configured to cause the UE to determine that an RLC PDU of the one or more RLC PDUs satisfies a condition when a packet data convergence protocol (PDCP) discard timer of a corresponding PDCP service data unit (SDU) is expired.

14. The UE of claim 1, wherein the at least one processor is configured to cause the UE to trigger a radio link failure (RLF) procedure based at least in part on the threshold number of retransmissions being satisfied.

15. A method performed by a user equipment (UE), the method comprising:
receiving, a configuration associated with radio link control (RLC) of the UE, wherein the configuration indicates a threshold number of retransmissions for reporting one or more sequence numbers (SNs) associated with one or more RLC protocol data units (PDUs) and a timer associated with retransmission of the reporting of the one or more SNs associated with the one or more RLC PDUs;
transmitting an SN report that indicates the one or more SNs associated with the one or more RLC PDUs;
activating the timer according to the configuration and in response to the transmitted SN report; and
setting a value of a retransmission counter according to the configuration and in response to the transmitted SN report.

16. The method of claim 15, further comprising:
performing one or more retransmissions of the SN report; and
incrementing the value of the retransmission counter for each of the one or more performed retransmissions of the SN report.

17. The method of claim 16, further comprising performing a retransmission of the SN report in response to an expiry of the timer.

18. The method of claim 16, further comprising:
receiving a status report that indicates a negative acknowledgement (NACK) associated with reception of at least one RLC PDU of the one or more RLC PDUs; and
performing a retransmission of the SN report based at least in part on the received status report.

19. A processor for wireless communication, comprising:
at least one controller coupled with at least one memory and configured to cause the processor to:
receive a configuration message associated with radio link control (RLC) of a user equipment (UE), wherein the configuration indicates a threshold number of retransmissions for reporting one or more sequence numbers (SNs) associated with one or more RLC protocol data units (PDUs) and a timer associated with retransmission of the reporting of the one or more SNs associated with the one or more RLC PDUs;
transmit an SN report that indicates the one or more SNs associated with the one or more RLC PDUs;
activate the timer according to the configuration and in response to the transmitted SN report; and
set a value of a retransmission counter according to the configuration and in response to the transmitted SN report.

20. A network entity for wireless communication, comprising:
at least one memory; and
at least one processor coupled with the at least one memory and configured to cause the network entity to:
configure, for radio link control (RLC) associated with a user equipment (UE), a threshold number of retransmissions for reporting one or more sequence numbers (SNs) associated with one or more RLC protocol data units (PDUs) and a timer associated with retransmission of the reporting of the one or more SNs associated with the one or more RLC PDUs; and
transmit, to the UE, a configuration indicating the threshold number of retransmissions and the timer.
